(19) United States
(12) Patent Application Publication
(10) Pub. No.: US 2026/0174247 A1
(43) Pub. Date: Jun. 25, 2026

(54) INFLATABLE BODY STRUCTURE

(71) Applicant: Intex Marketing Ltd., Tortola (VG)

(72) Inventors: Zhi Xiong Huang, Fujian (CN); Ying Biao Zhang, Fujian (CN); Zhi Wen Zhou, Fujian (CN)

(73) Assignee: Intex Marketing Ltd., Tortola (VG)

(21) Appl. No.: 19/127,822

(22) PCT Filed: Nov. 10, 2023
(86) PCT No.: PCT/IB2023/061399

§ 371 Date: May 7, 2025

(30) Foreign Application Priority Data
Nov. 10, 2022 (CN) 202223001930.8
Nov. 10, 2022 (CN) 202223002129.5

(51) Int. Cl. A47C 27/08; A47C 19/02; A47C 27/10; A47C 27/12; B29C 65/00; B60R 21/233

(52) U.S. Cl. CPC A47C 27/082; A47C 19/022; A47C 27/081; A47C 27/087; A47C 27/10; A47C 27/127; B29C 66/4722; B60R 21/233

(57) ABSTRACT

An inflatable body may include a top panel, a bottom panel, and at least one enclosure belt coupled to the top panel and the bottom panel to form a chamber therein. The inflatable body may include at least one of an oblique panel, a spacer, and an inner enclosure belt formed of a low ductility material.

### RELATED APPLICATIONS

This application is related to Chinese Application No. CN202223001930.8 filed on Nov. 10, 2022, and Chinese Application No. CN202223002129.5 filed on Nov. 10, 2022, the disclosures of which are expressly incorporated by reference herein.

### FIELD OF THE DISCLOSURE

The present disclosure relates to inflatable products, and particularly inflatable products including components formed of low ductility materials.

### BACKGROUND OF THE DISCLOSURE

Inflatable products are light in weight and easy to carry and collect. They are not only suitable for temporary use, but, further, are being gradually used as normal day-to-day furniture. For example, inflatable beds are becoming more common as inflatable furniture for everyday use. To improve a user's comfort, inflatable beds may include double chambers. That is, inflatable beds may include an inner chamber and an outer chamber arranged so that the outer chamber is formed on the outer perimeter of the inner chamber. When in use, the user may set the air pressure of the outer chamber to be higher than that of the inner chamber, for example.

Additionally or alternatively, inflatable beds may include a top panel, a bottom panel, an enclosure belt, and an inner structure. The top panel, the bottom panel, and the enclosure belt form a chamber, and the inner structure is arranged in the chamber so that the inner structure's upper end and lower end are connected to the top panel and the bottom panel, respectively. To facilitate support at the edge of the inflatable bed to avoid said edge being too soft, the inflatable bed may also include an upper oblique panel and a lower oblique panel. The upper oblique panel is arranged in the chamber so that the upper edge of the upper oblique panel is attached to the top panel and the lower edge of the upper oblique panel is attached to the enclosure belt, and the lower oblique panel is arranged in the chamber so that the upper edge of the lower oblique panel is attached to the enclosure belt and the bottom edge of the lower oblique panel is attached to the bottom panel.

However, inflatable products are typically made of polyvinyl chloride (“PVC”) or thermoplastic polyurethane (“TPU”), each of which have a certain ductility. As such, when inflating the inflatable bed or similar inflatable product having double chambers, although the air pressure of the inner chamber and the outer chamber may be set to differing pressures, during such use the dividing structure between the inner chamber and the outer chamber may be extended under the action of the air pressure, so that the internal pressure between the inner chamber and the outer chamber tends toward being the same pressure. As such, the purpose intended to be achieved through the design of the double chamber inflatable bed is not achieved. Additionally, when the inflatable bed or similar inflatable product is inflated to a high pressure, upper and lower oblique panels are easy to deform in such a way that when the pressure of the corresponding product is reduced, the edge of the bed becomes too soft.

### SUMMARY

The present disclosure relates to an inflatable body including a top panel, a bottom panel, and at least one enclosure belt coupled to the top panel and the bottom panel to form a chamber therein. The inflatable body includes at least one of an oblique panel, a spacer, and an inner enclosure belt formed of a low ductility material.

In an exemplary embodiment of the present disclosure, an inflatable bed body structure is provided. The inflatable bed body structure comprising: a top panel; an enclosure belt with a first edge coupled to the top panel; a bottom panel coupled to a second edge of the enclosure belt so that the bottom panel is positioned opposite from the top panel. The top panel, the enclosure belt, and the bottom panel form an chamber therebetween. The inflatable bed body structure further comprising an oblique panel having a first edge coupled to one of the top panel and the bottom panel and a second edge coupled to the enclosure belt. The oblique panel is formed from a low ductility material having a ductility value of from and including about 1% to and including about 30%.

In another exemplary embodiment of the present disclosure, an inflatable bed body structure is provided. The inflatable bed body structure comprising: a top panel; an enclosure belt with a first edge coupled to the top panel; a bottom panel coupled to a second edge of the enclosure belt so that the bottom panel is positioned opposite from the top panel and the top panel, the enclosure belt, and the bottom panel form an internal chamber; at least one tensioning structure arranged within the chamber; a first oblique panel having a first edge coupled to the top panel and a second edge coupled to the enclosure belt; and a second oblique panel having a first edge coupled to the enclosure belt and a second edge coupled to the bottom panel. A first edge of the at least one tensioning structure coupled to the top panel and a second edge of the at least one tensioning structure coupled to the bottom panel. The first oblique panel and the second oblique panel are each formed of a low ductility material.

In a further exemplary embodiment of the present disclosure, an inflatable bed body structure is provided. The inflatable bed body structure comprising: a top panel; an outer enclosure belt with a first edge coupled to the top panel; a bottom panel coupled to a second edge of the outer enclosure belt so that the bottom panel is arranged opposite of the top panel so that the top panel; and an inner enclosure belt having a first edge coupled to the top panel and a second edge coupled to the bottom panel. The outer enclosure belt and the bottom panel form a first chamber. The inner enclosure positioned within the first chamber so that the inner enclosure belt, the top panel, and the bottom panel form a second chamber. The inner enclosure belt being formed of a low ductility material.

Additional features and advantages of the present disclosure will become apparent to those skilled in the art upon consideration of the following description.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 illustrates a perspective view of an inflatable body having a double chamber;

FIG. 2 illustrates a partial section view of the inflatable body of FIG. 1;

FIG. 3 illustrates a perspective view of the inflatable body of FIG. 1, wherein an enclosure belt has been omitted to illustrate the interior of said inflatable body;

FIG. 4 illustrates a partial section view of a second inflatable body;

FIG. 5 illustrates a partial enlargement of the second inflatable body of FIG. 6;

FIG. 6 illustrates a perspective view of the second inflatable body of FIG. 6, wherein an enclosure belt has been omitted to illustrate the interior of said inflatable body;

FIG. 7 illustrates a perspective view of a third inflatable body;

FIG. 8 illustrates a section of the third inflatable body of FIG. 7; and

FIG. 9 illustrates a perspective view of the third inflatable body of FIG. 7, wherein an enclosure belt has been omitted to illustrate the interior of said inflatable body;

FIG. 10 illustrates a partial section of the inflatable body of FIG. 7;

FIG. 11 illustrates a structural view of a first low ductility material of an inflatable body;

FIG. 12 illustrates a structural view of a second low ductility material of an inflatable body;

FIG. 13 illustrates an exemplary tensioning structure; and

FIG. 14 illustrates an exemplary strand of an exemplary tensioning structure.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the described embodiments is thereby intended. Any alterations and further modifications in the described embodiments, and any further applications of the principles of the embodiments as described herein are contemplated as would normally occur to one skilled in the art to which the described embodiments relate. While certain embodiments are shown in great detail, it will be apparent to those skilled in the relevant art that some features that are not relevant to the described embodiments may not be shown for the sake of clarity.

In the description of the present disclosure, it should be noted that the terms “up”, “down”, “inside”, “outside”, “top/bottom”, etc. indicate the orientation or position relationship based on the orientation or position relationship shown in the attached drawings, only for the convenience of describing the present disclosure and simplifying the description, rather than indicating or implying that the device or component referred to must have a specific orientation, or be constructed and operated in a specific orientation. Therefore, it cannot be understood as a limitation on the present disclosure. In addition, the terms “first” and “second” are only used to describe and cannot be understood as indicating or implying relative importance.

In the description of the present disclosure, it should be noted that unless otherwise specified and limited, the terms “installation”, “set with”, “set/connected”, “connected”, etc. should be understood broadly. For example, “connected” can be a wall mounted connection, a detachable connection, or an integrated connection, can be a mechanical connection, can be an electrical connection, can be directly connected, or can be indirectly connected through an intermediate medium, can be the internal connection between two components, and for ordinary technical personnel in this field, the specific meaning of the above terms in the present disclosure can be understood in a specific situation.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

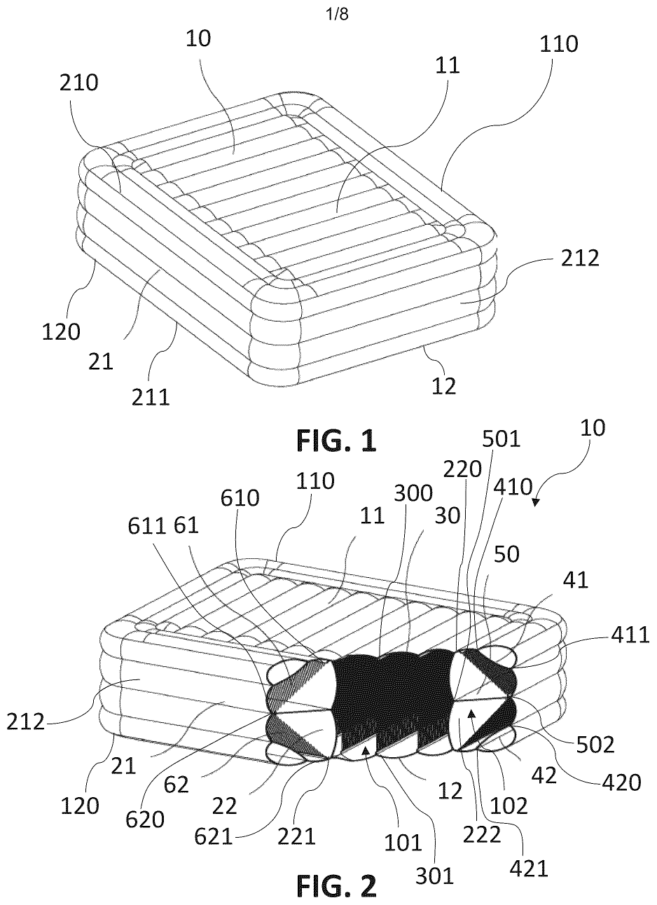

Referring initially to FIG. 1, an inflatable bed body structure 10 is disclosed, including a top panel 11, a bottom panel 12, and an outer enclosure belt 21. Outer enclosure belt 21 includes a first edge 210 which couples with top panel 11 around a perimeter edge 110 of top panel 11 and a second edge 211 which couples with bottom panel 12 around a perimeter edge 120 of bottom panel 12 to form an external sidewall 212 of inflatable bed body structure 10. In some embodiments, enclosure belt 21 includes multiple pieces connected together for form the external sidewall 212.

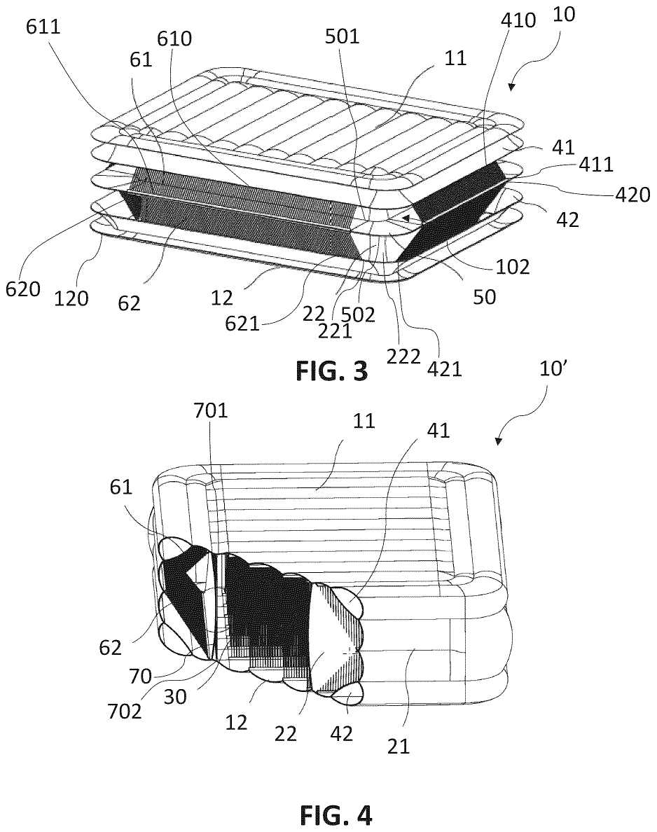

Referring additionally to FIGS. 2-3, inflatable bed body structure 10 may further include an inner enclosure belt 22 having a first edge 220 which couples with top panel 11 at a position interior of top panel 11 relative to perimeter edge 110 of top panel 11. Inner enclosure belt 22 also includes a second edge 221 which couples with bottom panel 12 at a position interior of bottom panel 12 relative to perimeter edge 120 of bottom panel 12 to form an internal wall 222 along an inner perimeter 100 of inflatable bed body structure 10 internal to external sidewall 212, forming an inner chamber 101 between internal wall 222, top panel 11, and bottom panel 12 and an outer chamber 102 between internal wall 222, top panel 11, bottom panel 12, and external sidewall 212. Inner enclosure belt 22 may be parallel with and concentric with outer enclosure belt 22.

One or more inner tensioning structures 30 may be arranged within inner chamber 101. Each inner tensioning structure 30 may include a first edge 300 coupled to top panel 11 and a second edge 301 coupled to bottom panel 12. As illustrated in FIG. 2, inflatable bed body structure 10 may include a plurality of inner tensioning structures 30 arranged laterally and generally parallel relative to other inner tensioning structures 30 within inner chamber 101.

Still referring to FIGS. 2-3, inflatable bed body structure 10 may further include spacer 50 arranged in outer chamber 102. A first edge 501 of spacer 50 may be coupled to inner enclosure belt 22 and a second edge 502 of spacer 50 may be coupled to outer enclosure belt 21. Spacer 50 may be formed of a low ductility material to mitigate shape variable in the direction of outer chamber 102 to inner chamber 101 and improve pressure stability of outer chamber 102.

Inflatable bed body structure 10 may further include a first oblique panel 41 and a second oblique panel 42 arranged within outer chamber 102. First oblique panel 41 may include a first edge 410 coupled to top panel 11 and a second edge 411 coupled to outer enclosure belt 21. First edge 410 of first oblique panel 41 may be coupled to top panel 11 at a position between inner enclosure belt 22 and outer enclosure belt 21. Second oblique panel 42 may include a first edge 420 coupled to outer enclosure belt 21 and a second edge 421 coupled to bottom panel 12. Second edge 421 of second oblique panel 42 may be coupled to bottom panel 12 at a position between inner enclosure belt 22 and outer enclosure belt 21. As illustrated, first oblique panel 41 may be arranged above spacer 50, while second oblique panel 42 may be arranged below spacer 50. Each of first oblique panel 41 and second oblique panel 42 may extend around the perimeter of inflatable bed body 10.

Still referring to FIGS. 2-3, a first oblique tensioning structure 61 and a second oblique tensioning structure 62 may be arranged within outer chamber 102 First oblique tensioning structure 61 may include a first edge 610 coupled to top panel 11 and a second edge 611 coupled to outer enclosure belt 21. First edge 610 of first oblique tensioning structure 61 may be coupled to top panel 11 at a position adjacent to inner enclosure belt 22 or at least nearer to inner enclosure belt 22 than outer enclosure belt 21. Second oblique tensioning structure 62 may include a first edge 620 coupled to outer enclosure belt 21 and a second edge 621 coupled to bottom panel 12. Second edge 621 of second oblique tensioning structure 62 may be coupled to bottom panel 12 at a position adjacent to inner enclosure belt 22 or at least nearer to inner enclosure belt 22 than outer enclosure belt 21. As illustrated, first oblique tensioning structure 61 may be arranged above spacer 50, while second oblique tensioning structure 61 may be arranged below spacer 50.

First oblique panel 41, second oblique panel 42, first oblique tensioning structure 61, and/or second oblique tensioning structure 62 may be formed of a low ductility material to mitigate deformation of outer chamber 102 to facilitate maintenance of stable air pressure within outer chamber 102 and ensure a constant or nearly constant air pressure difference between inner chamber 101 and outer chamber 102. Similarly, inner enclosure belt 22 may be formed of a low ductility material to mitigate shape variable in the direction of outer chamber 102 to inner chamber 101 and improve pressure stability of outer chamber 102.

Now referring to FIGS. 4-6, a second inflatable bed body structure 10′is illustrated. Inflatable bed body structure 10′includes a similar structure and similar components to inflatable bed body structure 10 described above in relation to FIGS. 1-3 except as otherwise described herein, wherein like components have like reference numbers.

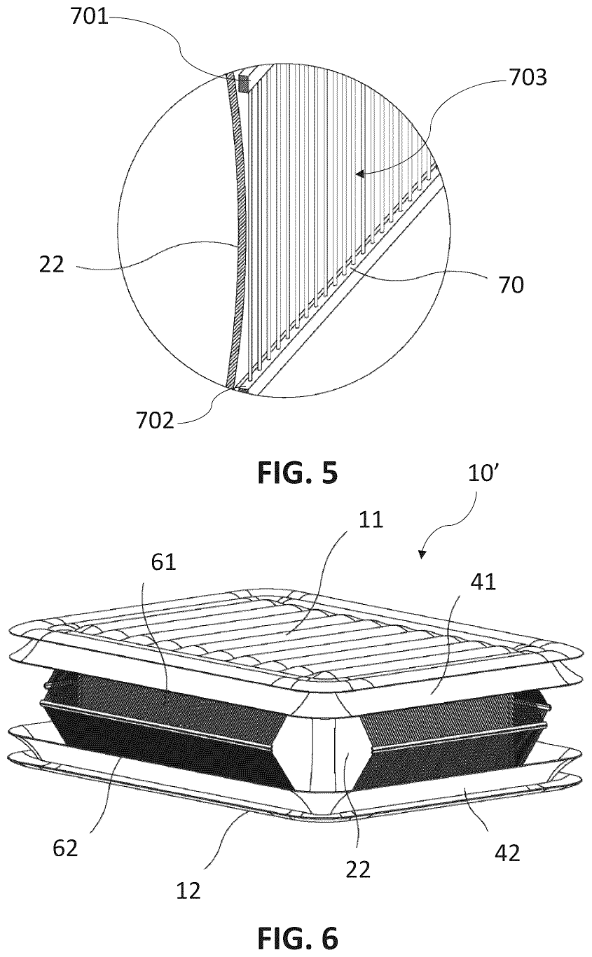

For example, still referring to FIGS. 4-6, inflatable bed body structure 10′does not include a spacer 50, but instead includes a reinforced tensioning structure 70. Perimeter tensioning structure 70 includes a first edge 701 coupled to top panel 11 and a second edge 702 coupled to bottom panel 12. As shown in FIG. 5, reinforced tensioning structure 70 includes a plurality of reinforcement fibers 703, which extend from first edge 701 to second edge 702 to provide reinforcement properties to reinforced tensioning structure 70. Reinforced tensioning structure 70 may be positioned immediately adjacent to inner enclosure belt 22 and limits extension of inner enclosure belt 22 in the direction of inner chamber 101, facilitating stability of outer chamber 102 and improving pressure retention of inner chamber 101.

Still referring to FIGS. 4-6, reinforced tensioning structure 70 is illustrated as being positioned within inner chamber 101; however, in other embodiments, reinforced tensioning structure 70 may be positioned within outer chamber 102 immediate adjacent inner enclosure belt 22. While the embodiments provided herein describe spacer 50 and reinforced tensioning structure 70 as belonging to separate embodiments of inflatable bed body structure 10′, other embodiments may include both of reinforced tensioning structure 70 and spacer 50.

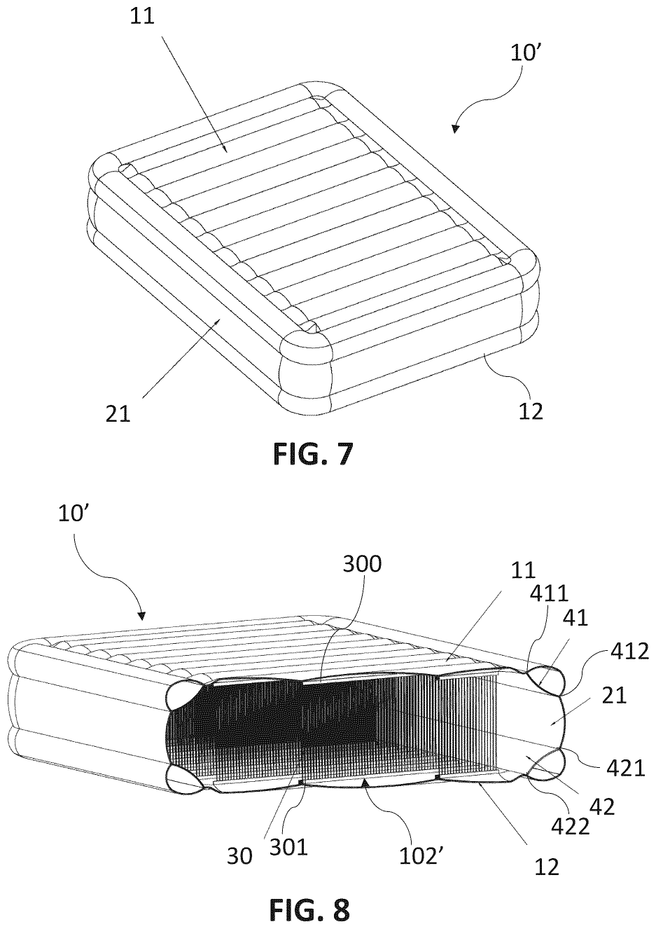

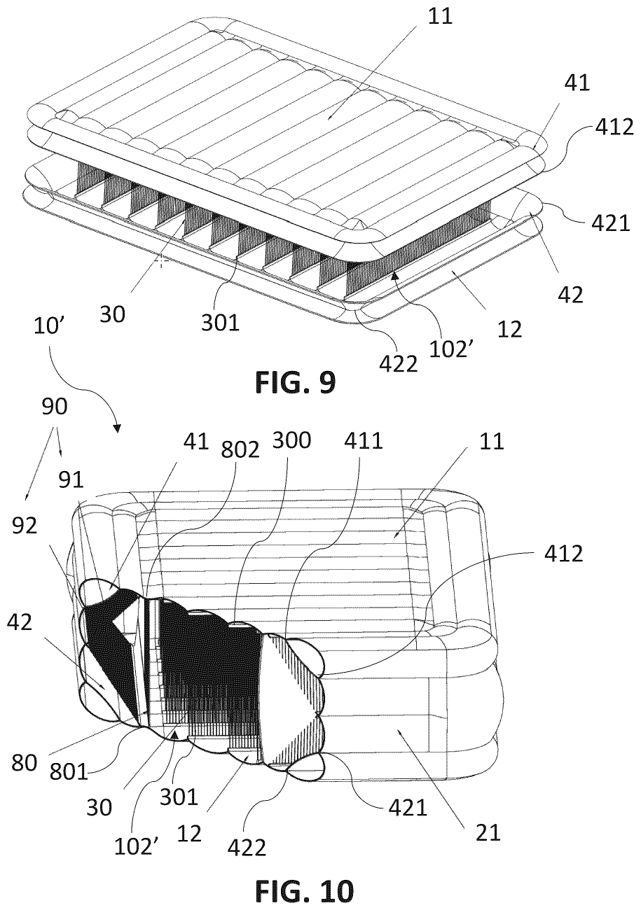

Now referring to FIGS. 7-10, a third inflatable bed body structure 10″ is illustrated. Inflatable bed body structure 10″ includes a similar structure and similar components to inflatable bed body structure 10 and 10′described above in relation to FIGS. 1-6, except as otherwise described herein, wherein like components have like reference numbers.

For example, inflatable bed body structure 10″ includes top panel 11, bottom panel 12, and outer enclosure belt 21 forming a chamber 102′. One or more inner tensioning structures 30 may be arranged within chamber 102′. Each inner tensioning structure 30 may include a first edge 300 coupled to top panel 11 and a second edge 301 coupled to bottom panel 12. As illustrated in FIGS. 8-10, inflatable bed body structure 10 may include a plurality of inner tensioning structures 30 arranged laterally and generally parallel relative to other inner tensioning structures 30 within chamber 102′.

Inflatable bed body structure 10″ further includes a first oblique panel 41 and a second oblique panel 42 arranged within chamber 102′. First oblique panel 41 includes a first edge 411 coupled to top panel 11 and a second edge 412 coupled to outer enclosure belt 21. As illustrated in FIGS. 8 and 10, first oblique panel 41 may extend around a perimeter of inflatable bed body structure 10″. Similarly, second oblique panel 42 includes a first edge 421 coupled to outer enclosure belt 21 and a second edge 422 coupled to bottom panel 12. Second oblique panel 42 may extend around a perimeter of inflatable bed body structure 10″. One or both of first oblique panel 41 and second oblique panel 42 may be formed of low ductility material as discussed further herein.

First oblique panel 41 and second oblique panel 42 facilitate support of the edges of the inflatable bed body 10″. In some embodiments, as shown in FIG. 10, inflatable bed body 10″ may include an oblique tensioning structure 90 arranged within chamber 102′. Such embodiments may include inflatable bed bodies having a certain threshold height or a height greater than said threshold height, for example. However, an inflatable bed body of any height may include the benefits provided herein of using oblique tensioning structure 90 and/or reinforced tensioning structure 80 as described further herein. A first edge 901 of oblique tensioning structure 90 may be coupled to one of top panel 11 or bottom panel 12, with a second edge 902 of oblique tensioning structure 70 being coupled to outer enclosure belt 21.

Still referring to FIG. 10, in yet other embodiments, two oblique tensioning structures 90 may be included, such as first oblique tensioning structure 91 and second oblique tensioning structure 92, for example. First oblique tensioning structure 91 may include a first edge 910 coupled to top panel 11 and a second edge 911 coupled to outer enclosure belt 21.

Second oblique tensioning structure 92 may include a first edge 920 coupled to outer enclosure belt 21 and a second edge 921 coupled to bottom panel 12. Embodiments of inflatable bed body 10″ including any combination of oblique tensioning structures 90, 91, 92 may mitigate the deformation amplitude of the edge of inflatable bed body 10″ and improve support provided by inflatable bed body 10″.

In some embodiments including first oblique tensioning structure 91 and second oblique tensioning structure 92, inflatable bed body 10″ may further include a reinforced tensioning structure 80 arranged within chamber 102′. Reinforced tensioning structure 80 may be positioned outside of the arrangement of inner tensioning structure(s) 40 and adjacent to or near outer enclosure belt 21. In other words, reinforced tensioning structure 80 may be positioned between inner tensioning structure(s) 40 and outer enclosure belt 21. In some embodiments, reinforced tensioning structure 80 may be arranged parallel to outer enclosure belt 21. Reinforced tensioning structure 80 may include a first edge 801 coupled to first oblique tensioning structure 91 and a second edge 802 coupled to second oblique tensioning structure 92. In other embodiments, first edge 801 of reinforced tensioning structure 80 may be coupled to top panel 11 while second edge 802 of reinforced tensioning structure 80 is coupled to bottom panel 12.

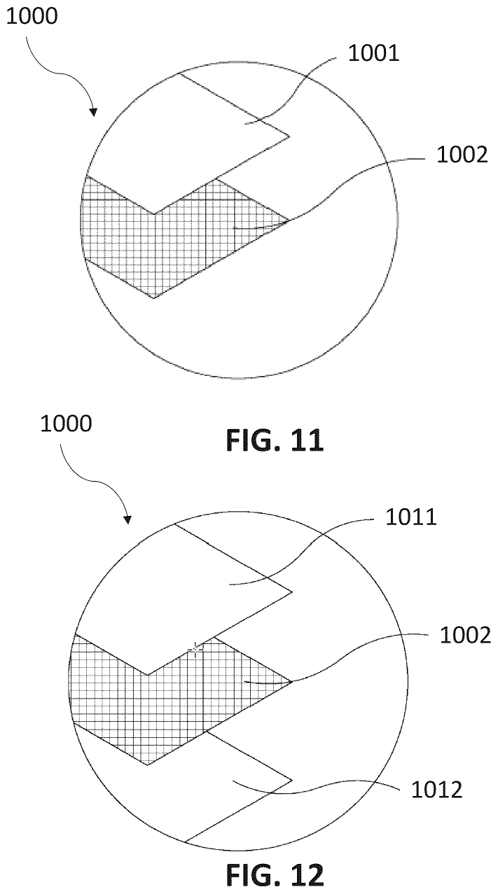

“Low ductility material” as discussed herein refers to one or more materials which collectively have a ductility value of 1%-30%. For example, such materials may have a ductility value of 1%, 2%, 3%, 4%, 5%, 10%, 15%, 20%, 25%, 36%, 27%, 28%, 29%, 30%, or any ductility value therebetween. Referring to FIG. 11, low ductility material 1000 may include an attachment layer 1001 and a strand layer 1002 bonded with attachment layer 1001. In some embodiments, attachment layer 1001 may include a polyvinyl chloride (PVC) tape, a thermoplastic urethane (TPU) tape, or another adhesive suitable for the application discussed herein. In some embodiments, strand layer 1002 may include crossed strands forming pores as shown in FIGS. 11 and 12, individual spaced apart strands, a mesh, a fabric, and other suitable arrangements.

As illustrated in FIG. 11, low ductility material 1000 may be formed by the adhesion of only one strand layer 1002 and one attachment layer 1001. As shown in FIG. 12, low ductility material 1000 may be formed by the adhesion of a single strand layer 1002 and two attachment layers 1001. For example, in some embodiments, attachment layer 1001 may include an upper attachment layer 1011 and a lower attachment layer 1012, with strand layer 1002 sandwiched between upper attachment layer 1011 and lower attachment layer 1012.

Exemplary tensioning structures which may be implemented for any of the tensioning structures disclosed herein are disclosed in U.S. Pat. No. 10,165,869 and PCT Published Application No. PCT/US 2023/025268 filed Jun. 14, 2023, the entire disclosures of which are expressly incorporated by reference herein.

An exemplary tensioning structure in accordance with the present disclosure utilizes thin and flexible string or wire-like strands which join two members, such as top panel 11 and bottom panel 12, to one another. The strands are firmly connected to the adjacent members, such as top panel 11 and bottom panel 12, via an intermediate material, such as a strip or sheet, and the intermediate material is in turn firmly connected to the adjacent members. The area of contact between intermediate material and the attached strands may be manipulated to impart a connection strength commensurate with the tensile strength of the strand. Similarly, the area of contact between the intermediate material and the adjacent member may also be manipulated to impart a member/tensioning structure connection strength commensurate with the aggregate tensile strength of all strands in the tensioning structure.

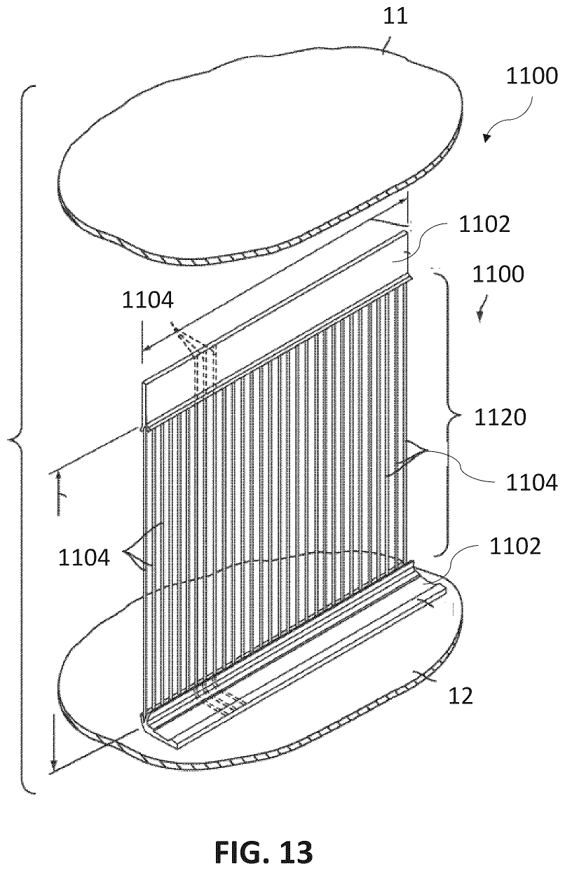

Turning now to FIG. 13, tensioning structure 1100 is shown joining top panel 11 and bottom panel 12. In the illustrated embodiment, tensioning structure 1100 includes upper and lower weld strips 1102 connected to one another by a plurality of substantially parallel strands 1104 that define a gap portion extending between a gap between upper and lower sheets 11, 12. The upper and lower weld strips 1102 are in turn welded to the upper material 11 and the lower material 12, respectively, such that forces urging upper and lower materials 11, 12 are encountered by tension in strands 1104.

Optionally, reinforcing strands may be provided along the longitudinal extent of weld strip 31 (i.e., substantially perpendicular to strands 32). Reinforcing strands, when provided, may be coupled to tensile strands 1104, such as by folding strands 1104 over reinforcing strands, tying reinforcing strands and strands 1104 to one another, or adhesively securing reinforcing strands and strands 1104 to one another.

The plurality of strands 1104 in the tensioning structure 1100 as shown in FIG. 13 are arranged such that the strands 1104 are substantially parallel to one another when strands 1104 are pulled taut (i.e., when weld strips 1102 are drawn away from one another represented as spacing 1120). In addition, adjacent pairs of strands 1104 may have even intervals therebetween, such that a substantially constant tensile strength of tensioning structure 1100 is maintained across the longitudinal extent of weld strips 1102. In an exemplary embodiment, strands 1104 may extend along the entire width of weld strips 1102, as illustrated in FIG. 13, such that a large area of contact between strands 1104 and weld strips 1102 is achieved. For clarity, FIG. 13 illustrate only a limited number of strands 1104 affixed to strips 1102 in this way, it being appreciated that all strands 1104 in a tensioning structure 1100 may be so affixed.

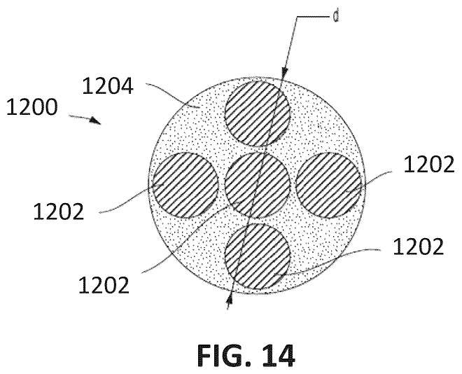

Turning to FIG. 14, a cross-section of an exemplary strand 1200 which may be used in tensioning structure 1100 is shown. Each strand 1200 may be a multifilament structure including at least two (illustratively, five) filaments 1202. Each filament 1202 may itself contain multiple filament yarns. Filaments 1202 may be twisted into a cable-like structure and may further include a binder or adhesive layer 1204 which retains an intended configuration of filaments 1202 relative to one another, and aids in fixation of strands 1200 to strips 1102. The filaments 1202 may define a weight of 50 Decitex (dtex), it being understood that dtex is defined as the mass of strand 1200 in grams per 10,000 meters of strand 1200. The filaments 1202 may be no greater than 1,000 dtex. Each strand 1200 may have a denier of at least 50D, it being understood that denier is the mass of filament 1202 in grams per 9,000 meters of filament 1202. The denier of each strand 1200 may be no greater than 2,500D. The overall diameter d (shown, e.g., in FIG. 14) of strand 1200 may be at least 0.10 and no greater than 0.14 mm. Additional details regarding exemplary strands and attachment structures, such as weld strips or weld sheets, are disclosed in PCT Published Application No. PCT/US2023/025268, the disclosure of which is expressly incorporated by reference herein.

### EXAMPLES

Example: 1. An inflatable bed body structure comprising: a top panel; an enclosure belt with a first edge coupled to the top panel; a bottom panel coupled to a second edge of the enclosure belt so that the bottom panel is positioned opposite from the top panel. The top panel, the enclosure belt, and the bottom panel form an chamber therebetween. The inflatable bed body structure further comprising an oblique panel having a first edge coupled to one of the top panel and the bottom panel and a second edge coupled to the enclosure belt. The oblique panel is formed from a low ductility material having a ductility value of from and including about 1% to and including about 30%.

Example: 2. The inflatable bed body structure of Example 1, wherein the oblique panel is arranged at a lateral edge of the inflatable bed body structure within the chamber.

Example: 3. The inflatable bed body structure of any one of Examples 1-2, further comprising a second oblique panel having a first edge coupled at the other of the top panel and the bottom panel and a second edge coupled to the enclosure belt.

Example: 4. The inflatable bed body structure of Example 3, wherein the second oblique panel is arranged vertically adjacent to the oblique panel.

Example: 5. The inflatable bed body of any one of Examples 1-4, further comprising an oblique tensioning structure having a first edge coupled to one of the top panel and the bottom panel and a second edge coupled to the enclosure belt. The oblique tensioning structure arranged at a longitudinal edge of the inflatable bed body structure within the chamber.

Example: 6. The inflatable bed body of any one of Examples 1-5, further comprising an inner enclosure belt arranged within the chamber. The inner enclosure belt including a first edge coupled to the top panel and a second edge coupled to the bottom panel so that the inner enclosure belt is concentric with and parallel to the enclosure belt and the top panel. The bottom panel, and the inner enclosure belt form an inner chamber therebetween.

Example: 7. The inflatable bed body of Example 6, further comprising a spacer with a first edge coupled to the inner enclosure belt and a second edge coupled to the enclosure belt.

Example: 8. The inflatable bed body of any one of Examples 1-7, further comprising a reinforced tensioning structure arranged within the chamber and further comprising a first edge coupled to the top panel and a second edge coupled to the bottom panel.

Example: 9. An inflatable bed body structure comprising a top panel; an enclosure belt with a first edge coupled to the top panel; a bottom panel coupled to a second edge of the enclosure belt so that the bottom panel is positioned opposite from the top panel and the top panel, the enclosure belt, and the bottom panel form an internal chamber; at least one tensioning structure arranged within the chamber; a first oblique panel having a first edge coupled to the top panel and a second edge coupled to the enclosure belt; and a second oblique panel having a first edge coupled to the enclosure belt and a second edge coupled to the bottom panel. A first edge of the at least one tensioning structure coupled to the top panel and a second edge of the at least one tensioning structure coupled to the bottom panel. The first oblique panel and the second oblique panel are each formed of a low ductility material.

Example: 10. The inflatable bed body structure of Example 9, wherein the ductility value of the low ductility material is from and including about 1% to and including about 30%.

Example: 11. The inflatable bed body structure of any one of Examples 9-10, wherein at least one of the first oblique panel and the second oblique panel comprises an attachment layer and a strand layer coupled to the attachment layer.

Example: 12. The inflatable bed body structure of Example 11, wherein the attachment layer comprises a first attachment layer and a second attachment layer.

Example: 13. The inflatable bed body structure of Example 12, wherein the strand layer is positioned between the first attachment layer and the second attachment layer.

Example: 14. The inflatable bed body structure of Example 11, wherein the attachment layer comprises at least one of PVC tape and TPU tape.

Example: 15. The inflatable bed body structure of any one of Examples 9-14, wherein the inflatable bed body structure further comprises an oblique tensioning structure arranged in the chamber, the oblique tensioning structure including a first edge coupled to one of the top panel and the bottom panel and a second edge coupled to the enclosure belt.

Example: 16. The inflatable bed body structure of Example 15, wherein the oblique tensioning structure comprises a first oblique tensioning structure and a lower oblique tensioning structure. The first oblique tensioning structure includes a first edge coupled to the top panel and a second edge coupled to the enclosure belt. The second oblique tensioning structure includes a first edge coupled to the enclosure belt and a second edge coupled to the bottom panel.

Example: 17. The inflatable bed body structure of Example 16, further comprising a reinforced tensioning structure positioned between the at least one inner tensioning structure and the enclosure belt. The reinforced tensioning structure including a first edge coupled to the first oblique tensioning structure and a second edge coupled to the second oblique tensioning structure.

Example: 18. The inflatable bed body structure of any one of Examples 9-16, further comprising a reinforced tensioning structure positioned between the at least one inner tensioning structure and the enclosure belt, the reinforced tensioning structure including a first edge coupled to the top panel and a second edge coupled to the bottom panel.

Example: 19. An inflatable bed body structure, comprising: a top panel; an outer enclosure belt with a first edge coupled to the top panel; a bottom panel coupled to a second edge of the outer enclosure belt so that the bottom panel is arranged opposite of the top panel so that the top panel; and an inner enclosure belt having a first edge coupled to the top panel and a second edge coupled to the bottom panel. The outer enclosure belt and the bottom panel form a first chamber. The inner enclosure positioned within the first chamber so that the inner enclosure belt, the top panel, and the bottom panel form a second chamber. The inner enclosure belt being formed of a low ductility material.

Example: 20. The inflatable bed body structure of Example 19, further comprising: a first oblique panel arranged within the first chamber, the first oblique panel having a first edge coupled to the top panel and a second edge coupled to the outer enclosure belt; and a second oblique panel arranged within the first chamber, the second oblique panel having a first edge coupled to the outer enclosure belt and a second edge coupled to the bottom panel.

Example: 21. The inflatable bed body structure of Example 20, wherein the first oblique panel and the second oblique panel are each formed of the low ductility material.

Example: 22. The inflatable bed body structure of any one of Examples 19-21, further comprising a spacer arranged within the first chamber, the spacer having a first edge coupled to the outer enclosure belt and a second edge coupled to the inner enclosure belt.

Example: 23. The inflatable bed body structure of Example 22, wherein the spacer is formed of a low ductility material.

Example: 24. The inflatable bed body structure of any one of Examples 19-23, further comprising: a first oblique tensioning structure arranged within the first chamber, the first oblique tensioning structure having a first edge coupled to the top panel and a second edge coupled to the outer enclosure belt and a second oblique tensioning structure arranged within the first chamber. The second oblique tensioning structure having a first edge coupled to the outer enclosure belt and a second edge coupled to the bottom panel.

Example: 25. The inflatable bed body structure of any one of Examples 19-24, further comprising a reinforced tensioning structure arranged within the second chamber adjacent to the inner enclosure belt and having a first edge coupled to the top panel and a second edge coupled to the bottom panel.

Example: 26. The inflatable bed body structure of any one of Examples 19-25, wherein the ductility value of the low ductility material is from and including about 1% to and including about 30%.

Example: 27. The inflatable bed body structure of any one of Examples 19-26, wherein the low ductility material comprises an attachment layer and a strand layer bonded to the attachment layer.

Example: 28. The inflatable bed body structure of Example 27, wherein the attachment layer includes a first attachment layer and a second attachment layer.

Example: 29. The inflatable bed body structure of Example 28, wherein the strand layer is arranged between the first attachment layer and the second attachment layer.

While the embodiments disclosed herein have been described as having exemplary designs, said embodiments can be further modified within the spirit and scope of this disclosure. This application is therefore intended to cover any variations, uses, or adaptations of the described embodiments using general principles. Further, this application is intended to cover such departures from the present disclosure as come within known or customary practice in the art to which this disclosure pertains.

1. An inflatable bed body structure comprising:
a top panel;
an enclosure belt with a first edge coupled to the top panel a bottom panel coupled to a second edge of the enclosure belt so that the bottom panel is positioned opposite from the top panel and the top panel, the enclosure belt, and the bottom panel form an chamber therebetween; and
an oblique panel having:
a first edge coupled to one of the top panel and the bottom panel; and
a second edge coupled to the enclosure belt;
wherein the oblique panel is formed from a low ductility material having a ductility value of from and including about 1% to and including about 30%.

2. The inflatable bed body structure of claim 1, wherein the oblique panel is arranged at a lateral edge of the inflatable bed body structure within the chamber.

3. The inflatable bed body structure of claim 1, further comprising a second oblique panel having a first edge coupled at the other of the top panel and the bottom panel and a second edge coupled to the enclosure belt.

4. The inflatable bed body structure of claim 3, wherein the second oblique panel is arranged vertically adjacent to the oblique panel.

5. The inflatable bed body of claim 1, further comprising an oblique tensioning structure having a first edge coupled to one of the top panel and the bottom panel and a second edge coupled to the enclosure belt, the oblique tensioning structure arranged at a longitudinal edge of the inflatable bed body structure within the chamber.

6. The inflatable bed body of claim 1, further comprising an inner enclosure belt arranged within the chamber, the inner enclosure belt including a first edge coupled to the top panel and a second edge coupled to the bottom panel so that the inner enclosure belt is concentric with and parallel to the enclosure belt and the top panel, the bottom panel, and the inner enclosure belt form an inner chamber therebetween.

7. The inflatable bed body of claim 6, further comprising a spacer with a first edge coupled to the inner enclosure belt and a second edge coupled to the enclosure belt.

8. The inflatable bed body of claim 1, further comprising a reinforced tensioning structure arranged within the chamber and further comprising a first edge coupled to the top panel and a second edge coupled to the bottom panel.

9. An inflatable bed body structure comprising:
a top panel;
an enclosure belt with a first edge coupled to the top panel;
a bottom panel coupled to a second edge of the enclosure belt so that the bottom panel is positioned opposite from the top panel and the top panel, the enclosure belt, and the bottom panel form an internal chamber;
at least one tensioning structure arranged within the chamber, a first edge of the at least one tensioning structure coupled to the top panel and a second edge of the at least one tensioning structure coupled to the bottom panel;
a first oblique panel having a first edge coupled to the top panel and a second edge coupled to the enclosure belt; and
a second oblique panel having a first edge coupled to the enclosure belt and a second edge coupled to the bottom panel;
wherein the first oblique panel and the second oblique panel are each formed of a low ductility material.

10. The inflatable bed body structure of claim 9, wherein the ductility value of the low ductility material is from and including about 1% to and including about 30%.

11. The inflatable bed body structure of claim 9, wherein at least one of the first oblique panel and the second oblique panel comprises an attachment layer and a strand layer coupled to the attachment layer.

12. The inflatable bed body structure of claim 11, wherein the attachment layer comprises a first attachment layer and a second attachment layer.

13. The inflatable bed body structure of claim 12, wherein the strand layer is positioned between the first attachment layer and the second attachment layer.

14. The inflatable bed body structure of claim 11, wherein the attachment layer comprises at least one of PVC tape and TPU tape.

15. The inflatable bed body structure of claim 9, wherein the inflatable bed body structure further comprises an oblique tensioning structure arranged in the chamber, the oblique tensioning structure including:
a first edge coupled to one of the top panel and the bottom panel; and
a second edge coupled to the enclosure belt.

16. The inflatable bed body structure of claim 15, wherein the oblique tensioning structure comprises a first oblique tensioning structure and a lower oblique tensioning structure, and wherein:
the first oblique tensioning structure includes a first edge coupled to the top panel and a second edge coupled to the enclosure belt; and
the second oblique tensioning structure includes a first edge coupled to the enclosure belt and a second edge coupled to the bottom panel.

17. The inflatable bed body structure of claim 16, further comprising a reinforced tensioning structure positioned between the at least one inner tensioning structure and the enclosure belt, the reinforced tensioning structure including a first edge coupled to the first oblique tensioning structure and a second edge coupled to the second oblique tensioning structure.

18. The inflatable bed body structure of claim 9, further comprising a reinforced tensioning structure positioned between the at least one inner tensioning structure and the enclosure belt, the reinforced tensioning structure including a first edge coupled to the top panel and a second edge coupled to the bottom panel.

19. An inflatable bed body structure, comprising:
a top panel;
an outer enclosure belt with a first edge coupled to the top panel;
a bottom panel coupled to a second edge of the outer enclosure belt so that the bottom panel is arranged opposite of the top panel so that the top panel, the outer enclosure belt, and the bottom panel form a first chamber; and
an inner enclosure belt having a first edge coupled to the top panel and a second edge coupled to the bottom panel, the inner enclosure positioned within the first chamber so that the inner enclosure belt, the top panel, and the bottom panel form a second chamber, the inner enclosure belt being formed of a low ductility material.

20. The inflatable bed body structure of claim 19, further comprising:
a first oblique panel arranged within the first chamber, the first oblique panel having a first edge coupled to the top panel and a second edge coupled to the outer enclosure belt; and
a second oblique panel arranged within the first chamber, the second oblique panel having a first edge coupled to the outer enclosure belt and a second edge coupled to the bottom panel.

21. The inflatable bed body structure of claim 20, wherein the first oblique panel and the second oblique panel are each formed of the low ductility material.

22. The inflatable bed body structure of claim 19, further comprising a spacer arranged within the first chamber, the spacer having a first edge coupled to the outer enclosure belt and a second edge coupled to the inner enclosure belt.

23. The inflatable bed body structure of claim 22, wherein the spacer is formed of a low ductility material.

24. The inflatable bed body structure of claim 19, further comprising:
a first oblique tensioning structure arranged within the first chamber, the first oblique tensioning structure having a first edge coupled to the top panel and a second edge coupled to the outer enclosure belt; and
a second oblique tensioning structure arranged within the first chamber, the second oblique tensioning structure having a first edge coupled to the outer enclosure belt and a second edge coupled to the bottom panel.

25. The inflatable bed body structure of claim 19, further comprising a reinforced tensioning structure arranged within the second chamber adjacent to the inner enclosure belt and having a first edge coupled to the top panel and a second edge coupled to the bottom panel.

26. The inflatable bed body structure of claim 19, wherein the ductility value of the low ductility material is from and including about 1% to and including about 30%.

27. The inflatable bed body structure of claim 19, wherein the low ductility material comprises an attachment layer and a strand layer bonded to the attachment layer.

28. The inflatable bed body structure of claim 27, wherein the attachment layer includes a first attachment layer and a second attachment layer.

29. The inflatable bed body structure of claim 28, wherein the strand layer is arranged between the first attachment layer and the second attachment layer.
